(19) United States
(12) Patent Application Publication
(10) Pub. No.: US 2023/0311929 A1
(43) Pub. Date: Oct. 5, 2023

(54) AUTONOMOUS VEHICLE INTERACTION WITH CHASSIS CONTROL SYSTEM TO PROVIDE ENHANCED DRIVING MODES

(71) Applicant: GM CRUISE HOLDINGS LLC, San Francisco, CA (US)

(72) Inventors: Shad Laws, Redwood City, CA (US); Kar Chun Tung, San Francisco, CA (US)

(73) Assignee: GM CRUISE HOLDINGS LLC, San Francisco, CA (US)

(21) Appl. No.: 17/710,366

(22) Filed: Mar. 31, 2022

(51) Int. Cl. B60W 60/00; B60W 50/08; B60W 40/09

(52) U.S. Cl. CPC B60W 60/001; B60W 50/082; B60W 40/09; B60W 2540/30

(57) ABSTRACT

For one embodiment, an autonomous vehicle system interacts with a chassis control system to provide enhanced driving modes based on current sensor signals. A computer-implemented method of selecting a driver mode of an autonomous vehicle is described. The computer-implemented method includes initializing, with a chassis control system, driving operations in a conservative driver mode of an autonomous vehicle. The computer-implemented further includes receiving, with a computing system, sensor signals from a sensor system of the autonomous vehicle and determining whether the sensor signals are received periodically. For periodically received sensor signals, the computer-implemented determines a capability level of a plurality of capability levels for the autonomous vehicle and switches from the conservative driver mode to a permissive driver mode when the capability level indicates full capability of the autonomous vehicle.

### TECHNICAL FIELD

Embodiments described herein generally relate to the field of autonomous vehicles, and more particularly relate to an autonomous vehicle that interacts with a chassis control system to provide enhanced driving modes.

### BACKGROUND

Autonomous vehicles, also known as self-driving cars, driverless vehicles, and robotic vehicles, may be vehicles that use multiple sensors to sense the environment and move without human input. Automation technology in the autonomous vehicles may enable the vehicles to drive on roadways and to accurately and quickly perceive the vehicle's environment, including obstacles, signs, and traffic lights. Autonomous technology may utilize map data that can include geographical information and semantic objects (such as parking spots, lane boundaries, intersections, crosswalks, stop signs, traffic lights) for facilitating driving safety. The vehicles can be used to pick up passengers and drive the passengers to selected destinations. The vehicles can also be used to pick up packages and/or other goods and deliver the packages and/or goods to selected destinations.

### SUMMARY

For one embodiment, an autonomous vehicle interacts with a chassis control system to provide enhanced driving modes based on current sensor signals. A computer-implemented method of selecting a driver mode of an autonomous vehicle is described. The computer-implemented method includes initializing, with a chassis control system, driving operations in a conservative driver mode of an autonomous vehicle. The computer-implemented further includes receiving, with a computing system, sensor signals from a sensor system of the autonomous vehicle and determining whether the sensor signals are received periodically. For periodically received sensor signals, the computer-implemented determines a capability level of a plurality of capability levels for the autonomous vehicle and switches from the conservative driver mode to a permissive driver mode when the capability level indicates full capability of the autonomous vehicle.

Other features and advantages of embodiments of the present invention will be apparent from the accompanying drawings and from the detailed description that follows below.

### BRIEF DESCRIPTION OF THE DRAWINGS

FIG. 1 illustrates an autonomous vehicle and remote computing system architecture in accordance with one embodiment.

FIG. 2 illustrates an exemplary autonomous vehicle 200 having multiple driver modes in accordance with one embodiment.

FIG. 3 illustrates a computer-implemented method for selecting a driver mode based on signals from a sensor system in accordance with one embodiment.

FIG. 4 illustrates an automated driving system in accordance with one embodiment.

FIG. 5 illustrates a driver mode diagram for dynamically selecting different driver modes based on sensed signals of a sensor system of an autonomous vehicle in accordance with one embodiment.

FIG. 6 is a block diagram of a vehicle 1200 having driver assistance according to an embodiment.

### DETAILED DESCRIPTION OF EMBODIMENTS

Some self-driving vehicles have manual driving mode (level 0), driver assistance mode (level 1) with the vehicle controlled by the driver but some driver assist features, or partial automation mode (level 2) with the vehicle having automated functions such as acceleration and steering but the driver remains engaged with the driver task and monitors an environment. The automated functions may have conservative settings and this negatively impacts collision avoidance for the vehicle.

An autonomous vehicle having an autonomous vehicle (AV) system to interact with a chassis control system to provide different driver modes and high performance collision avoidance is described. A high capability AV system provides more capable collision avoidance limits in nominal operation. The AV system switches between different driving modes (e.g., a conservative driving mode, enhanced aggressive driving mode, enhanced modified driving mode) based on real time driving conditions. The different driving modes are compatible with a canonical functional safety architecture. The AV provides fulfillment of maximum collision avoidance safety without disabling or turning off high-integrity systems for driving operations.

In the following description, for purposes of explanation, numerous specific details are set forth in order to provide a thorough understanding of the present invention. It will be apparent, however, to one skilled in the art that the present invention can be practiced without these specific details. In other instances, well-known structures and devices are shown in block diagram form in order to avoid obscuring the present invention.

Reference in the specification to “one embodiment” or “an embodiment” means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment. Likewise, the appearances of the phrase “in another embodiment,” or “in an alternate embodiment” appearing in various places throughout the specification are not all necessarily all referring to the same embodiment.

The following glossary of terminology and acronyms serves to assist the reader by providing a simplified quick-reference definition. A person of ordinary skill in the art may understand the terms as used herein according to general usage and definitions that appear in widely available standards and reference books.

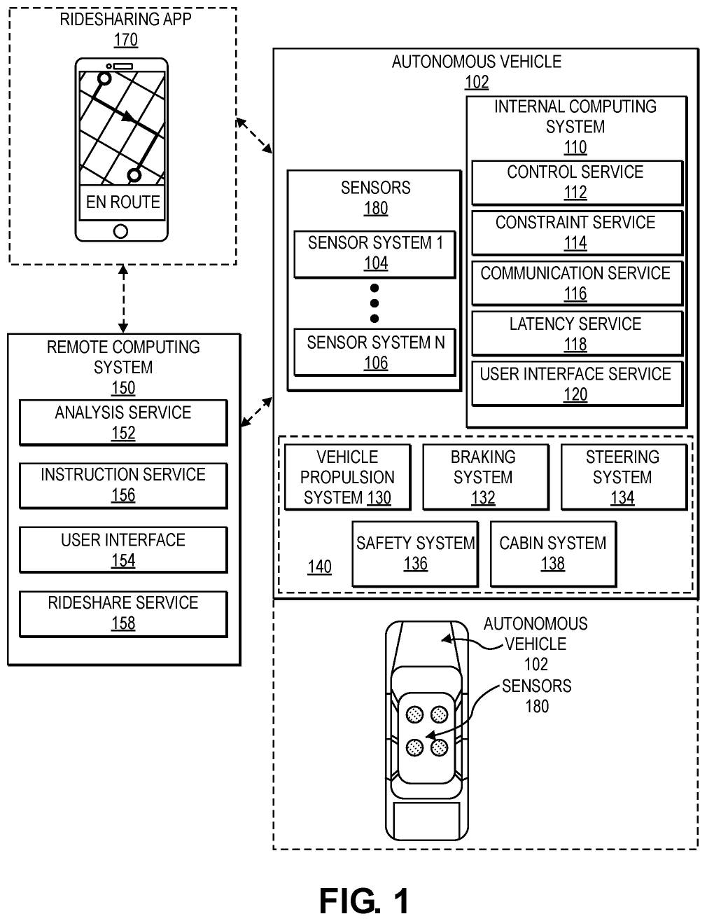

FIG. 1 illustrates an autonomous vehicle and remote computing system architecture in accordance with one embodiment. The autonomous vehicle 102 can navigate about roadways without a human driver based upon sensor signals output by sensor systems 180 of the autonomous vehicle 102. The autonomous vehicle 102 includes a plurality of sensor systems 180 (e.g., a first sensor system 104 through an Nth sensor system 106). The sensor systems 180 are of different types and are arranged about the autonomous vehicle 102. For example, the first sensor system 104 may be a camera sensor system and the Nth sensor system 106 may be a Light Detection and Ranging (LIDAR) sensor system to perform ranging measurements for localization.

The camera sensor system aids in classifying objects and tracking the objects over time. The camera sensor system also supports the identification of free space, among other things. The camera sensor system assists in differentiating various types of motor vehicles, pedestrians, bicycles, and free space. The camera sensor system can identify road objects such as construction cones, barriers, and signs and identify objects such as street signs, streetlights, trees and read dynamic speed limit signs. The camera sensor system also identifies attributes of other people and objects on the road, such as brake signals from cars, reverse lamps, turn signals, hazard lights, and emergency vehicles, and detect traffic light states and weather.

The LIDAR sensor system supports localization of the vehicle using ground and height reflections in addition to other reflections. The LIDAR sensor system supports locating and identifying static and dynamic objects in space around the vehicle (e.g., bikes, other vehicles, pedestrians), ground debris and road conditions, and detecting headings of moving objects on the road.

Other exemplary sensor systems include radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems such as Global Positioning System (GPS) receiver systems, accelerometers, gyroscopes, inertial measurement units (IMU), infrared sensor systems, laser rangefinder systems, ultrasonic sensor systems, infrasonic sensor systems, microphones, or a combination thereof. While four sensors 180 are illustrated coupled to the autonomous vehicle 102, it should be understood that more or fewer sensors may be coupled to the autonomous vehicle 102.

The autonomous vehicle 102 further includes several mechanical systems that are used to effectuate appropriate motion of the autonomous vehicle 102. For instance, the mechanical systems can include but are not limited to, a vehicle propulsion system 130, a braking system 132, and a steering system 134. The vehicle propulsion system 130 may include an electric motor, an internal combustion engine, or both. The braking system 132 can include an engine brake, brake pads, actuators, and/or any other suitable componentry that is configured to assist in decelerating the autonomous vehicle 102. In some cases, the braking system 132 may charge a battery of the vehicle through regenerative braking. The steering system 134 includes suitable componentry that is configured to control the direction of movement of the autonomous vehicle 102 during navigation.

The autonomous vehicle 102 further includes a safety system 136 that can include various lights and signal indicators, parking brake, airbags, etc. The autonomous vehicle 102 further includes a cabin system 138 that can include cabin temperature control systems, in-cabin entertainment systems, etc.

The autonomous vehicle 102 additionally comprises an internal computing system 110 (or AV system) that is in communication with the sensor systems 180 and the mechanical system 140 having systems 130, 132, 134, 136, and 138. The internal computing system includes at least one processor and at least one memory having computer-executable instructions that are executed by the processor. The computer-executable instructions can make up one or more services responsible for controlling the autonomous vehicle 102, communicating with remote computing system 150, receiving inputs from passengers or human co-pilots, logging metrics regarding data collected by sensor systems 180 and human co-pilots, etc.

The internal computing system 110 can include a control service 112 that is configured to control operation of a mechanical system 140 (or chassis control system), which includes vehicle propulsion system 130, the braking system 208, the steering system 134, the safety system 136, and the cabin system 138. The control service 112 receives sensor signals from the sensor systems 180 and communicates with other services of the internal computing system 110 to effectuate operation of the autonomous vehicle 102. In some embodiments, control service 112 may carry out operations in concert with one or more other systems of autonomous vehicle 102. The control service 112 can control and select driver modes of the autonomous vehicle 102 based on sensor signals from the sensor systems 180. In one example, the control service receives sensor signals on a periodic basis and determines a capability level (e.g., first capability level with full capability and good system health of components or systems of the autonomous vehicle with no hardware or software faults (or minor faults), second capability level with a degraded capability, third capability level with a further degraded capability, etc.) based on diagnostics of system health of the autonomous vehicle 102. For capability levels with better system health and capabilities, the control service 112 may select a more permissive driver mode that is primarily based on the sensor signals. For capability levels with worse system health and reduced capabilities, the control service 112 may select a conservative driver mode that primarily utilizes the mechanical system 140.

In another embodiment, the control service 112 does not receive sensor signals for a time period. The control service selects a conservative driving mode for this example.

The internal computing system 110 can also include a constraint service 114 to facilitate safe propulsion of the autonomous vehicle 102. The constraint service 116 includes instructions for activating a constraint based on a rule-based restriction upon operation of the autonomous vehicle 102. For example, the constraint may be a restriction upon navigation that is activated in accordance with protocols configured to avoid occupying the same space as other objects, abide by traffic laws, circumvent avoidance areas, etc. In some embodiments, the constraint service can be part of the control service 112.

The internal computing system 110 can also include a communication service 116. The communication service can include both software and hardware elements for transmitting and receiving signals from/to the remote computing system 150. The communication service 116 is configured to transmit information wirelessly over a network, for example, through an antenna array that provides personal cellular (long-term evolution (LTE), 3G, 4G, 5G, etc.) communication.

In some embodiments, one or more services of the internal computing system 110 are configured to send and receive communications to remote computing system 150 for such reasons as reporting data for training and evaluating machine learning algorithms, requesting assistance from remoting computing system or a human operator via remote computing system 150, software service updates, ridesharing pickup and drop off instructions etc.

The internal computing system 110 can also include a latency service 118. The latency service 118 can utilize timestamps on communications to and from the remote computing system 150 to determine if a communication has been received from the remote computing system 150 in time to be useful. For example, when a service of the internal computing system 110 requests feedback from remote computing system 150 on a time-sensitive process, the latency service 118 can determine if a response was timely received from remote computing system 150 as information can quickly become too stale to be actionable. When the latency service 118 determines that a response has not been received within a threshold, the latency service 118 can enable other systems of autonomous vehicle 102 or a passenger to make necessary decisions or to provide the needed feedback.

The internal computing system 110 can also include a user interface service 120 that can communicate with cabin system 138 in order to provide information or receive information to a human co-pilot or human passenger. In some embodiments, a human co-pilot or human passenger may be required to evaluate and override a constraint from constraint service 114, or the human co-pilot or human passenger may wish to provide an instruction to the autonomous vehicle 102 regarding destinations, requested routes, or other requested operations.

As described above, the remote computing system 150 is configured to send/receive a signal from the autonomous vehicle 102 regarding reporting data for training and evaluating machine learning algorithms, requesting assistance from remote computing system 150 or a human operator via the remote computing system 150, software service updates, rideshare pickup and drop off instructions, etc.

The remote computing system 150 includes an analysis service 152 that is configured to receive data from autonomous vehicle 102 and analyze the data to train or evaluate machine learning algorithms for operating the autonomous vehicle 102 such as performing object detection for methods and systems disclosed herein. The analysis service 152 can also perform analysis pertaining to data associated with one or more errors or constraints reported by autonomous vehicle 102. In another example, the analysis service 152 is located within the internal computing system 110.

The remote computing system 150 can also include a user interface service 154 configured to present metrics, video, pictures, sounds reported from the autonomous vehicle 102 to an operator of remote computing system 150. User interface service 154 can further receive input instructions from an operator that can be sent to the autonomous vehicle 102.

The remote computing system 150 can also include an instruction service 156 for sending instructions regarding the operation of the autonomous vehicle 102. For example, in response to an output of the analysis service 152 or user interface service 154, instructions service 156 can prepare instructions to one or more services of the autonomous vehicle 102 or a co-pilot or passenger of the autonomous vehicle 102.

The remote computing system 150 can also include a rideshare service 158 configured to interact with ridesharing applications 170 operating on (potential) passenger computing devices. The rideshare service 158 can receive requests to be picked up or dropped off from passenger ridesharing app 170 and can dispatch autonomous vehicle 102 for the trip. The rideshare service 158 can also act as an intermediary between the ridesharing app 170 and the autonomous vehicle wherein a passenger might provide instructions to the autonomous vehicle to 102 go around an obstacle, change routes, honk the horn, etc.

The rideshare service 158 as depicted in FIG. 1 illustrates a vehicle 102 as a triangle en route from a start point of a trip to an end point of a trip, both of which are illustrated as circular endpoints of a thick line representing a route traveled by the vehicle. The route may be the path of the vehicle from picking up the passenger to dropping off the passenger (or another passenger in the vehicle), or it may be the path of the vehicle from its current location to picking up another passenger.

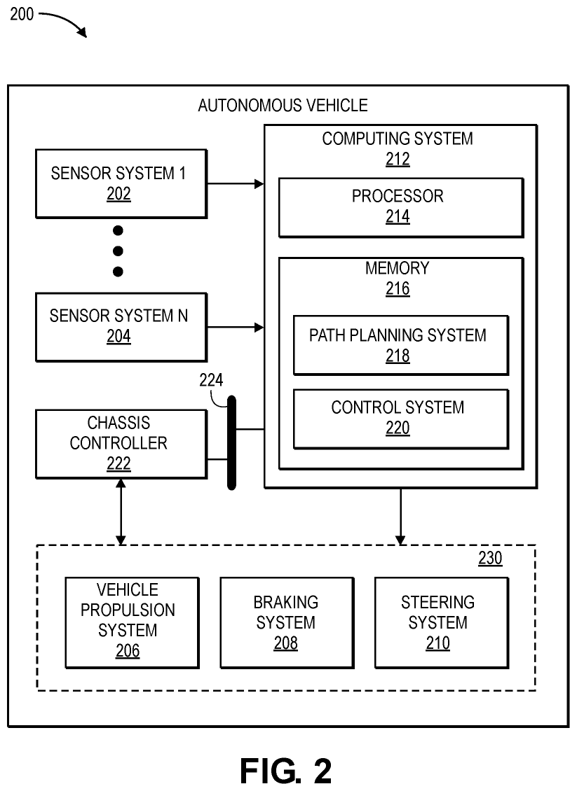

FIG. 2 illustrates an exemplary autonomous vehicle 200 having multiple driver modes in accordance with one embodiment. The autonomous vehicle 200 can navigate about roadways without a human driver based upon sensor signals output by sensor systems 202-204 of the autonomous vehicle 200. The autonomous vehicle 200 includes a plurality of sensor systems 202-204 (a first sensor system 202 through an Nth sensor system 204). The sensor systems 202-204 are of different types and are arranged about the autonomous vehicle 200. For example, the first sensor system 202 may be a camera sensor system and the Nth sensor system 204 may be a lidar sensor system. Other exemplary sensor systems include, but are not limited to, radar sensor systems, global positioning system (GPS) sensor systems, inertial measurement units (IMU), infrared sensor systems, laser sensor systems, sonar sensor systems, and the like. Furthermore, some or all of the of sensor systems 202-204 may be articulating sensors that can be oriented/rotated such that a field of view of the articulating sensors is directed towards different regions surrounding the autonomous vehicle 200.

The autonomous vehicle 200 further includes several mechanical systems that can be used to effectuate appropriate motion of the autonomous vehicle 200. For instance, the mechanical systems 230 can include but are not limited to, a vehicle propulsion system 206, a braking system 208, and a steering system 210. The vehicle propulsion system 206 may include an electric motor, an internal combustion engine, or both. The braking system 208 can include an engine break, brake pads, actuators, and/or any other suitable componentry that is configured to assist in decelerating the autonomous vehicle 200. The steering system 210 includes suitable componentry that is configured to control the direction of movement of the autonomous vehicle 200 during propulsion.

The autonomous vehicle 200 additionally includes a chassis controller 222 that is activated to manipulate the mechanical systems 206-210 when an activation threshold of the chassis controller 222 is reached.

The autonomous vehicle 200 further comprises a computing system 212 that is in communication with the sensor systems 202-204, the mechanical systems 206-210, and the chassis controller 222. While the chassis controller 222 is activated independently from operations of the computing system 212, the chassis controller 222 may be configured to communicate with the computing system 212, for example, via a controller area network (CAN) bus 224. The computing system 212 includes a processor 214 and memory 216 that stores instructions which are executed by the processor 214 to cause the processor 214 to perform acts in accordance with the instructions.

The memory 216 comprises a path planning system 218 and a control system 220. The path planning system 218 generates a path plan for the autonomous vehicle 200, wherein the path plan can be identified both spatially and temporally according to one or more impending timesteps. The path plan can include one or more maneuvers to be performed by the autonomous vehicle 200.

The control system 220 is configured to control the mechanical systems of the autonomous vehicle 200 (e.g., the vehicle propulsion system 206, the brake system 208, and the steering system 210) based upon an output from the sensor systems 202-204 and/or the path planning system 218. For instance, the mechanical systems can be controlled by the control system 220 to execute the path plan determined by the path planning system 218. Additionally or alternatively, the control system 220 may control the mechanical systems 206-210 to navigate the autonomous vehicle 200 in accordance with outputs received from the sensor systems 202-204.

The control system 220 can control and select driver modes of the autonomous vehicle 200 based on sensor signals from the sensor systems. In one example, the control system receives sensor signals on a periodic basis and determines a capability level (e.g., first capability level with full capability and good system health of components or systems of the autonomous vehicle, second capability level with a degraded capability, third capability level with a further degraded capability, etc.) based on diagnostics of system health of the autonomous vehicle. For capability levels with better system health and capabilities, the control system may select a more permissive driver mode that is primarily based on the sensor signals. For capability levels with worse system health and reduced capabilities, the control system may select a conservative driver mode that primarily utilizes the mechanical system 140 (or chassis control system).

In another embodiment, the control system does not receive sensor signals for a time period. The control system selects a conservative driving mode for this example.

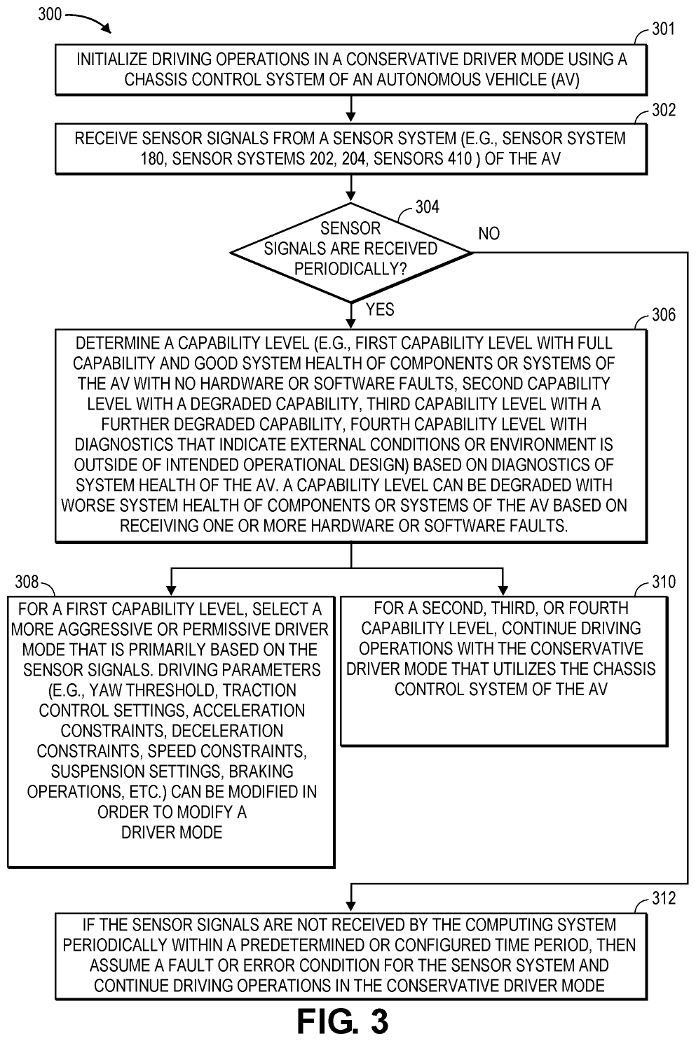

FIG. 3 illustrates a computer-implemented method for selecting a driver mode based on signals from a sensor system in accordance with one embodiment. In one example, sensor signals with sensor data can be obtained from different types of sensors (e.g., multiple distance measurement sensors) that are coupled to a device, which may be a vehicle, such as vehicle 102 of FIG. 1 or a vehicle 1200. This computer-implemented method can be performed by processing logic of a computing system that may comprise hardware (circuitry, dedicated logic, a processor, etc.), software (such as is run on a general purpose computer system or a dedicated machine or a device or control service 112), or a combination of both. The method can be performed by an internal computing system 110 or remote computing system 150 of FIG. 1, the computing system 212 of FIG. 2, systems 420, 422, systems 430, 432, or the system 1202.

At operation 301, the computer-implemented method initializes driving operations in a conservative driver mode that primarily uses a chassis control system.

At operation 302, the computer-implemented method receives sensor signals from a sensor system (e.g., sensor system 180, sensor systems 202, 204, sensors 410, sensor system 1214) of an autonomous vehicle. In one example, the sensors may be coupled or integrated with a vehicle or a computing system. The sensor signals can include one or more of sensed data from a sensor or error information to indicate hardware or software faults. A computing system may periodically receive the sensor signals.

At operation 304, the computer implemented method determines whether the sensor signals are received periodically within a predetermined or configured time period. If so, then at operation 306 the computer implemented method determines a capability level (e.g., first capability level with full capability and good system health of components or systems of the AV with no hardware or software faults, second capability level with a degraded capability, third capability level with a further degraded capability, fourth capability level with diagnostics that indicate external conditions or environment is outside of intended operational design) based on diagnostics of system health of the autonomous vehicle. A capability level can be degraded with worse system health of components or systems of the AV based on receiving one or more hardware or software faults (e.g., error values, software not functioning, loss of visibility for one or more sensors, loss of one or more sensors, safety module offline, erroneous CAN messages, etc.).

If good system health is determined based on the AV sensors, then the method provides a more aggressive high performance or permissive mode, which gives as much margin as possible to the AV computing system before a separate control system such as a chassis control system is permitted to provide stability control. The additional margin for the AV computing system can enhance performance and collision avoidance. If worse system health is determined, then the method provides a conservative driver mode, which utilizes the traditional chassis control system for stability control more frequently with less margin for control deviation. The computer implemented method can be an autonomous driving algorithm that switches between different driver modes dynamically based on the sensor signals.

For a first capability level, the computer implemented method may select a more aggressive or permissive driver mode that is primarily based on the sensor signals at operation 308. Driving parameters (e.g., yaw threshold, traction control settings, acceleration constraints, deceleration constraints, speed constraints, suspension settings, braking operations, etc.) can be modified in order to modify a driver mode.

For a second, third, or fourth capability level, the method may continue driving operations with the conservative driver mode that utilizes the mechanical systems of the vehicle for driving operations at operation 310.

If the sensor signals are not received by the computing system periodically within a predetermined or configured time period, then at operation 312 the computer-implemented method assumes a fault or error condition for the sensor systems and continues driving operations in the conservative driver mode.

The computer-implemented method can return from operations 308, 310, or 312 to operations 302 or 304 for a determination of whether sensor signals are received periodically.

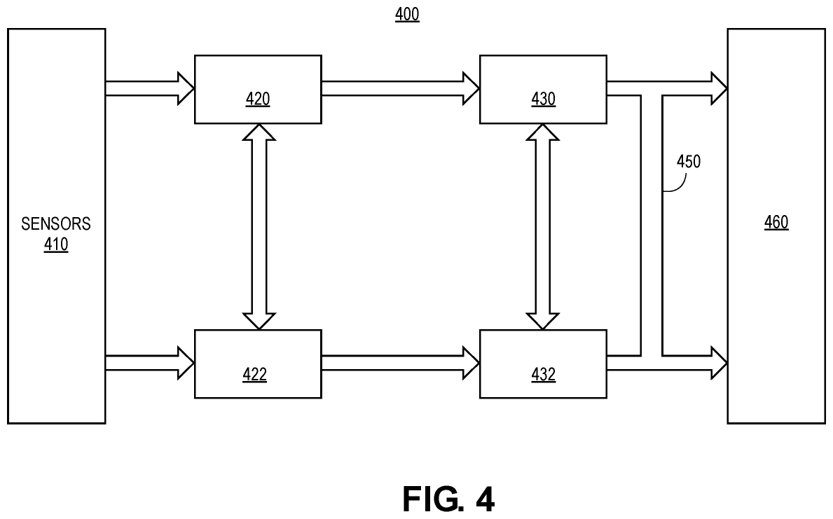

FIG. 4 illustrates an automated driving system in accordance with one embodiment. FIG. 4 illustrates the connectivity of sensors 410, AV computing systems 420, 422, AV integration computing systems 430, 432, and chassis control system 460. FIG. 4 also illustrates the optional redundancy built into the automated driving system 400 for fail-operational and fail-safe performance. Autonomous vehicles need a fault tolerant design such that main functionality is maintained even as portions of the AV system fail. Degraded capability levels (or degraded states) are the method by which individual failures are reported. Each degraded capability level or state is assigned a severity level (e.g., second capability level with a degraded capability, third capability level with a further degraded capability, fourth capability level with diagnostics that indicate conditions or environment is outside of intended operational design). Different capability levels can have different responses (e.g., issue to be investigated later in a day, issue to be investigated after current mission, perform pull over maneuver, stop in lane, hard brake) dependent on severity of the issue.

In one example, a significant portion of the sensor data is transmitted through Ethernet switches with diagnostic capabilities to the AV computing systems 420, 422. Camera data can be transmitted to the AV computing systems 420, 422 through low-voltage differential signaling (“LVDS”) buses. In one example, the AV computing systems 420, 422 are redundant to each other and have independent hardware, software, and power supplies. One serves as the Primary AV computing system and the other as the Secondary AV computing system. Both AV computing systems 420, 422 continuously process the sensor data inputs through their control algorithms to determine the appropriate path for the vehicle. The control information from the Primary AV computing system is normally utilized, while the Secondary AV computing system is available to assume this role within milliseconds if a fault is detected in the Primary AV computing system. Each AV computing system is connected via Ethernet connections and switches to another set of redundant computers, the AV Integration computing systems 430, 432. The systems 420, 422, 430, 432 together, along with their network connections, form a computer control system for the system 400. Each system 430, 432 independently monitors its associated system 420, 422 for processing integrity. The systems 430, 432 have monitoring agents monitoring their integrity. The systems 420, 422 monitor for AV level faults such as ethernet communications, LIDAR failures, late packets, etc. These failures will cause a temporary fault to be set and if the issue does not recover in a short predetermined time period (e.g., few seconds) then the failure can be escalated to a safe stop of the vehicle.

The systems 430, 432 are a final arbiter of the degraded levels or states of the vehicle. The data from the systems 430, 432 can be transferred to the systems 420, 422. The systems 430, 432 monitor specific electronic control units (ECUs) (e.g., brake control module, engine control module (ECM), powertrain control module, etc.) for faults. When an ECU level fault sets, then the systems 430, 432 set a corresponding degraded level or state. This degraded level or state is received by the systems 420, 422 to perform an appropriate response for severe level faults.

Each system 420, 422 uses feedback from the vehicle sensors and actuators of the chassis control system to continuously communicate commands to its associated system 430, 432, transmitting path information many times per second. More particularly, each system 420, 422 performs perception operations, as well as control system operations. Each system 430, 432 performs low level controls operations.

A perception system of systems 420, 422 receives information from the external sensors and builds a model of the world in three-dimensional space and over periods of time that can be used to plan a safe trajectory for the vehicle. This includes detecting and tracking motion and predicting future motion for relevant nearby objects like people, cyclists, and various motor vehicles. The model includes determining certainties and uncertainties related to the tracked objects and other attributes of the space around the vehicle. These certainties and uncertainties include those related to what can be detected, for example, due to weather conditions and due to occlusions by obstacles like cars in the vehicle's path.

With each updated local plan, the system 420, 422 provides a plan as a temporal discretized (over multiple seconds) set of commands including powertrain, brake, and steering commands.

In one embodiment, this local plan is transmitted from the systems 420, 422 to the systems 430, 432 one command at a time to be translated into actuator commands for the chassis control system 460. In another embodiment, this local plan is transmitted from the systems 420, 422 to the systems 430, 432 as a time sequence. In one example, each system 430, 432 sends the control commands, as vehicle control signals, over the Control Area Network (“CAN”) buses 450.

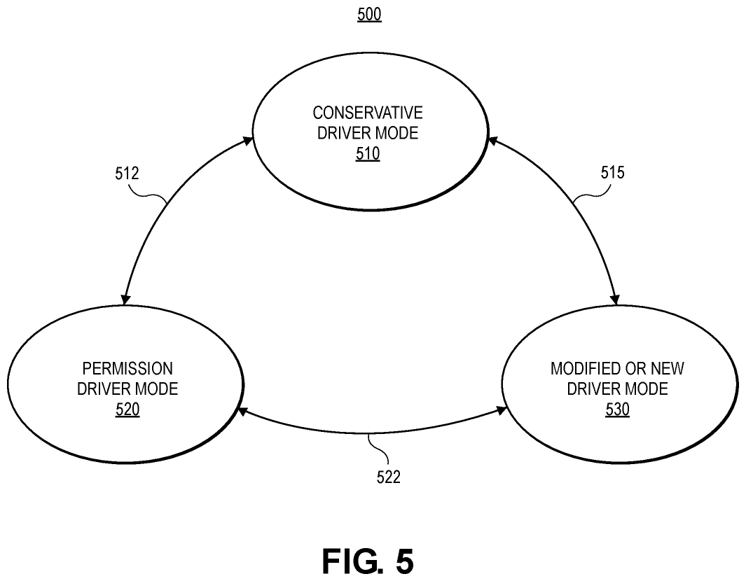

FIG. 5 illustrates a driver mode diagram for dynamically selecting different driver modes based on sensed signals of a sensor system of an autonomous vehicle in accordance with one embodiment. The driver mode diagram 500 includes different driver modes 510, 520, and 530 and switches or transitions between these modes with transitions 512, 515, 522. Initially a chassis control system can begin driving operations in a conservative driver mode 510 of an autonomous vehicle. A computing system (e.g., internal 110 or remoting computing system 150, the computing system 212, system 1202, AV systems 420, 422, AV integration systems 430, 432) receives sensor signals from a sensor system of the autonomous vehicle and determines whether the sensor signals are received periodically.

For periodically received sensor signals, the computing system determines a capability level of a plurality of capability levels for the autonomous vehicle and switches from the conservative driver mode to a permissive driver mode 520 when the capability level indicates full capability of the autonomous vehicle.

The plurality of capability levels include a first capability level with full capability of the sensor system, a second capability level with a degraded capability, a third capability level with a further degraded capability, and a fourth capability level with diagnostics that indicate conditions or an environment that is outside of intended operational design of the autonomous vehicle. Additional capability levels can also be provided and ranked with one or more lower capability levels causing a safe stop of the vehicle.

If the computing system receives one or more hardware or software faults, then a capability level of the sensor system is modified based on the one or more hardware or software faults.

For example, the computing system can switch from the permissive driver mode 520 to the conservative driver mode 510 when the capability level indicates a degraded capability of the sensor system due to the one or more hardware or software faults.

In another example, the second permissive driver mode is modified or new driver mode is created to generate a third permissive customized driver mode 530. The computing system can receive signals with parameters (e.g., yaw threshold, actuation behavior for lights, traction control settings, acceleration constraints, deceleration constraints, speed constraints, suspension settings, and braking operations) to be modified for the driver mode 530. The modified parameters can influence operation of the chassis control system.

The permissive driver mode may comprise an aggressive high performance mode with the sensor system being utilized for settings of driving parameters. The conservative driver mode utilizes the chassis control system for stability control and settings of driving parameters.

If the sensor signals are not received by the computing system periodically within a predetermined or configured time period, then a fault or error condition is assumed for the sensor systems and driving operations continue in the conservative driver mode 510 if currently in mode 510 or alternatively switch from modes 520 or 530 to mode 510.

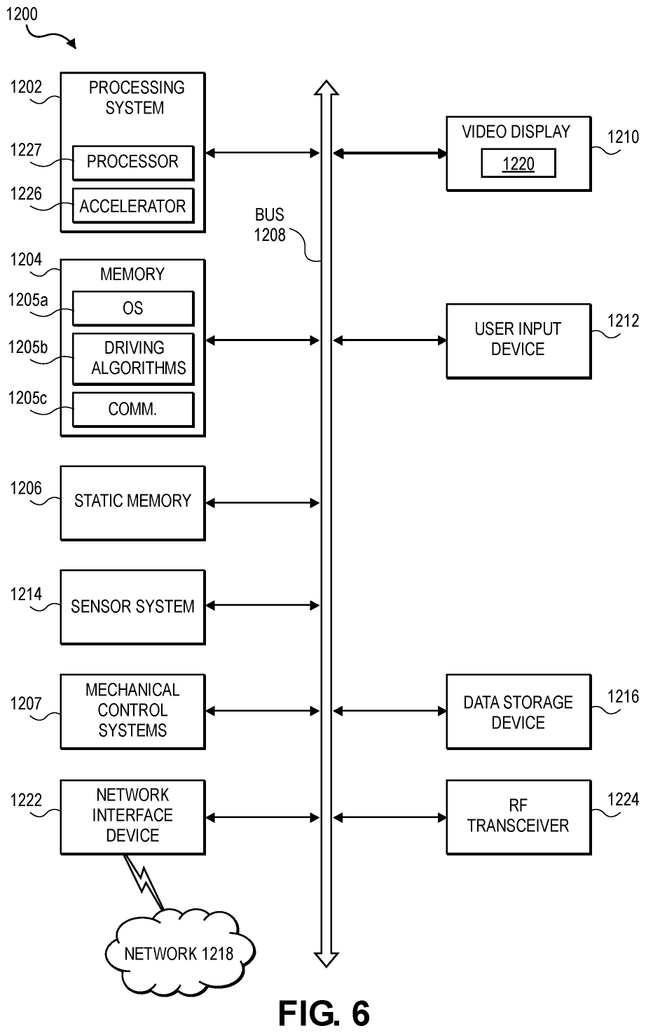

FIG. 6 is a block diagram of a vehicle 1200 having driver assistance according to an embodiment. Within the processing system 1202 (or computer system 1202) is a set of instructions (one or more software programs) for causing the machine to perform any one or more of the methodologies discussed herein including determining and selecting driver modes based on sensor signals. In alternative embodiments, the machine may be connected (e.g., networked) to other machines in a LAN, an intranet, an extranet, or the Internet. The machine can operate in the capacity of a server or a client in a client-server network environment, or as a peer machine in a peer-to-peer (or distributed) network environment, the machine can also operate in the capacity of a web appliance, a server, a network router, switch or bridge, event producer, distributed node, centralized system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The processing system 1202, as disclosed above, includes processing logic in the form of a general purpose instruction-based processor 1227 or an accelerator 1226 (e.g., graphics processing units (GPUs), FPGA, ASIC, etc.)). The general purpose instruction-based processor may be one or more general purpose instruction-based processors or processing devices (e.g., microprocessor, central processing unit, or the like). More particularly, processing system 1202 may be a complex instruction set computing (CISC) microprocessor, reduced instruction set computing (RISC) microprocessor, very long instruction word (VLIW) microprocessor, general purpose instruction-based processor implementing other instruction sets, or general purpose instruction-based processors implementing a combination of instruction sets. The accelerator may be one or more special-purpose processing devices such as an application specific integrated circuit (ASIC), a field programmable gate array (FPGA), a digital signal general purpose instruction-based processor (DSP), network general purpose instruction-based processor, many light-weight cores (MLWC) or the like. Processing system 1202 is configured to perform the operations and methods discussed herein. The exemplary vehicle 1200 includes a processing system 1202, main memory 1204 (e.g., read-only memory (ROM), flash memory, dynamic random access memory (DRAM) such as synchronous DRAM (SDRAM) or DRAM (RDRAM), etc.), a static memory 1206 (e.g., flash memory, static random access memory (SRAM), etc.), and a data storage device 1216 (e.g., a secondary memory unit in the form of a drive unit, which may include fixed or removable non-transitory computer readable storage medium), which communicate with each other via a bus 1208. The storage units disclosed herein may be configured to implement the data storing mechanisms for performing the operations and methods discussed herein. Memory 1206 can store code and/or data for use by processor 1227 or accelerator 1226. Memory 1206 include a memory hierarchy that can be implemented using any combination of RAM (e.g., SRAM, DRAM, DDRAM), ROM, FLASH, magnetic and/or optical storage devices. Memory may also include a transmission medium for carrying information-bearing signals indicative of computer instructions or data (with or without a carrier wave upon which the signals are modulated).

Processor 1227 and accelerator 1226 execute various software components stored in memory 1204 to perform various functions for system 1202. Furthermore, memory 1206 may store additional modules and data structures not described above.

Operating system 1205a includes various procedures, sets of instructions, software components and/or drivers for controlling and managing general system tasks and facilitates communication between various hardware and software components. Driving algorithms 1205b (e.g., object detection, segmentation, path planning, method 300, determining and selecting driver modes based on sensor signals, etc.) utilize sensor data from the sensor system 1214 to provide driver modes, object detection, segmentation, and driver assistance features (e.g., adaptive cruise control, collision avoidance systems, connecting smartphones for hands-free dialing, automatic braking, satellite navigation and traffic warnings, etc.) for different applications such as driving operations of vehicles. A communication module 1205c provides communication with other devices utilizing the network interface device 1222 or RF transceiver 1224.

The vehicle 1200 may further include a network interface device 1222. In an alternative embodiment, the processing system disclosed is integrated into the network interface device 1222 as disclosed herein. The vehicle 1200 also may include a video display unit 1210 (e.g., a liquid crystal display (LCD), LED, or a cathode ray tube (CRT)) connected to the computer system through a graphics port and graphics chipset, an input device 1212 (e.g., stylus), and a Graphic User Interface (GUI) 1220 (e.g., a touch-screen with input & output functionality) that is provided by the video display unit 1210.

The vehicle 1200 may further include a RF transceiver 1224 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/de-interleaving, spreading/dispreading, inverse fast Fourier transforming (IFFT)/fast Fourier transforming (FFT), cyclic prefix appending/removal, and other signal processing functions.

The data storage device 1216 may include a machine-readable storage medium (or more specifically a non-transitory computer readable storage medium) on which is stored one or more sets of instructions embodying any one or more of the methodologies or functions described herein. Disclosed data storing mechanism may be implemented, completely or at least partially, within the main memory 1204 and/or within the processing system 1202, the main memory 1204 and the data processing system 1202 also constituting machine-readable storage media.

In one example, the vehicle 1200 with driver assistance is an autonomous vehicle that may be connected (e.g., networked) to other machines or other autonomous vehicles using a network 1218 (e.g., LAN, WAN, cellular network, or any network). The vehicle can be a distributed system that includes many computers networked within the vehicle. The vehicle can transmit communications (e.g., across the Internet, any wireless communication) to indicate current conditions (e.g., an alarm collision condition indicates close proximity to another vehicle or object, a collision condition indicates that a collision has occurred with another vehicle or object, etc.). The vehicle can operate in the capacity of a server or a client in a client-server network environment, or as a peer machine in a peer-to-peer (or distributed) network environment. The storage units disclosed in vehicle 1200 may be configured to implement data storing mechanisms for performing the operations of autonomous vehicles.

The vehicle 1200 also includes sensor system 1214 and mechanical control systems 1207 (e.g., chassis control, vehicle propulsion system, driving wheel control, brake control, etc.). The system 1202 executes software instructions to perform different features and functionality (e.g., driving decisions) and provide a graphical user interface 1220 for an occupant of the vehicle. The system 1202 performs the different features and functionality for autonomous operation of the vehicle based at least partially on receiving input from the sensor system 1214 that includes lidar sensors, cameras, radar, GPS, and additional sensors. The system 1202 may be an electronic control unit for the vehicle.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A computer implemented method comprising:
initializing, with a chassis control system, driving operations in a conservative driver mode of an autonomous vehicle (AV);
receiving, with a computing system, sensor signals from a sensor system of the autonomous vehicle;
determining whether the sensor signals are received periodically;
for periodically received sensor signals, determining a capability level of a plurality of capability levels for the AV; and
switching from the conservative driver mode to a permissive driver mode when the capability level indicates full capability of the AV.

2. The computer implemented method of claim 1, wherein the plurality of capability levels comprise a first capability level with full capability of the AV, a second capability level with a degraded capability of the AV, a third capability level with a further degraded capability of the AV, and a fourth capability level with diagnostics that indicate conditions or an environment that is outside of intended operational design of the AV.

3. The computer implemented method of claim 1, further comprising:
receiving one or more hardware or software faults; and
modifying a capability level of the AV based on the one or more hardware or software faults.

4. The computer implemented method of claim 1, further comprising:
switching from the permissive driver mode to the conservative driver mode when the capability level indicates a degraded capability of the AV due to one or more hardware or software faults.

5. The computer implemented method of claim 1, wherein the permissive driver mode comprises an aggressive high performance mode with the sensor system being utilized for settings of driving parameters.

6. The computer implemented method of claim 1, wherein the conservative driver mode utilizes the chassis control system for stability control and settings of driving parameters.

7. The computer implemented method of claim 6, wherein the driving parameters comprise yaw threshold, traction control settings, acceleration constraints, deceleration constraints, speed constraints, suspension settings, and braking operations.

8. The computer implemented method of claim 1, wherein if the sensor signals are not received by the computing system periodically within a predetermined or configured time period, then a fault or error condition is assumed for the sensor systems and driving operations continue in the conservative driver mode.

9. A computing system, comprising:
a memory storing instructions; and
a processor coupled to the memory, the processor is configured to execute instructions to:
initialize driving operations in a conservative driver mode of an autonomous vehicle;
receive sensor signals from a sensor system of the autonomous vehicle;
determine whether the sensor signals are received periodically; and
for periodically received sensor signals, determine a capability level of a plurality of capability levels for the autonomous vehicle; and
switch from the conservative driver mode to a permissive driver mode when the capability level indicates full capability of the autonomous vehicle.

10. The computing system of claim 9, wherein the plurality of capability levels comprise a first capability level with full capability of the autonomous vehicle, a second capability level with a degraded capability, a third capability level with a further degraded capability, and a fourth capability level with diagnostics that indicate external conditions or an environment that is outside of intended operational design of the autonomous vehicle.

11. The computing system of claim 9, wherein the processor is configured to execute instructions to:
receive one or more hardware or software faults; and
modify a capability level of the autonomous vehicle based on the one or more hardware or software faults.

12. The computing system of claim 9, wherein the processor is configured to execute instructions to:
switch from the permissive driver mode to the conservative driver mode when the capability level indicates a degraded capability of the autonomous vehicle due to one or more hardware or software faults.

13. The computing system of claim 9, wherein the processor is configured to execute instructions to:
provide the permissive driver mode that includes an aggressive high performance mode with the sensor system being utilized for settings of driving parameters.

14. The computing system of claim 9, wherein the processor is configured to execute instructions to:
provide the conservative driver mode that utilizes chassis control system for stability control and settings of driving parameters.

15. The computing system of claim 9, wherein the processor is configured to execute instructions to:
modify the permissive driver mode to generate a modified customized permissive driver mode.

16. The computing system of claim 15, wherein the processor is configured to execute instructions to:
switch from the modified customized permissive driver mode to the conservative driver mode when the capability level indicates a degraded capability of the autonomous vehicle due to one or more hardware or software faults.

17. A non-transitory computer readable storage medium having embodied thereon a program, wherein the program is executable by a processor to perform a method of selecting a driver mode for a vehicle, the method comprising:
initializing driving operations in a first driver mode of the vehicle;
receiving sensor signals from a sensor system of the vehicle;
determining a capability level of a plurality of capability levels for the vehicle; and
switching from the first driver mode to a second permissive driver mode when the capability level indicates full capability of the vehicle.

18. The non-transitory computer readable storage medium of claim 17, the method further comprising:
modifying the second permissive driver mode to generate a third permissive driver mode based on recently received sensor signals.

19. The non-transitory computer readable storage medium of claim 18, wherein the third permissive driver mode has modified driving parameters in comparison to driving parameters of the second permissive driver mode.

20. The non-transitory computer readable storage medium of claim 17, wherein the method further comprises:
switching from the second permissive driver mode to the first driver mode when the capability level indicates a degraded capability of the vehicle due to one or more hardware or software faults.
